(19) United States
(12) Patent Application Publication
(10) Pub. No.: US 2008/0179264 A1
(43) Pub. Date: Jul. 31, 2008

(54) GLASSWARE OR STEMWARE DRYING MAT WITH STAINLESS STEEL SERVING TRAY

(76) Inventor: Franklin J. ABRAMS, Old Westbury, NY (US)

Correspondence Address: SUGHRUE MION, PLLC, 2100 PENNSYLVANIA AVENUE, N.W., SUITE 800, WASHINGTON, DC, 20037, US

(21) Appl. No.: 11/851,630

(22) Filed: Sep. 7, 2007

Related U.S. Application Data
(60) Provisional application No. 60/897,436, filed on Jan. 25, 2007.

(51) Int. Cl. A47L 19/04; F26B 1/00

(52) U.S. Cl. 211/41.3; 34/104; 34/440

(57) ABSTRACT

A mat for drying glassware or stemware includes a plurality of elevating portions, a plurality of notches in the elevating portions, a plurality of openings on a surface of the mat; and a plurality of ribs. The aerated design of the mat allows airflow through glasses to insure streak and spot-proof drying. A tray may be combined with the mat to catch runoff water dripping from the glass through the openings in the mat. The non-slip surface of the mat prevents delicate wine glasses from touching and prevents breakage.

### CROSS-REFERENCE TO RELATED APPLICATIONS

This application claims priority from U.S. Provisional Patent Application No. 60/897,436, filed on Jan. 25, 2007, the disclosure of which is incorporated herein in its entirety by reference.

### BACKGROUND OF THE INVENTION

1. Field of the Invention

Apparatuses and methods consistent with the present invention generally relate to a mat for drying glassware or stemware.

2. Description of the Related Art

Properly drying glassware or stemware is very important for maintaining its lifecycle. During the drying process, glassware or stemware may be damaged in form of scratches or cracks. Damage to the glassware or stemware reduces the strength of the glassware or stemware and the aesthetic pleasure from viewing the glassware or stemware.

In addition to damaging the glassware or stemware, the drying process may also leave streaks or spots on the glass.

One method for drying glassware or stemware is to use a dishtowel. The dishtowel is applied to the surface of the glassware or stemware and water droplets and condensation are absorbed by the dishtowel. A dishtowel, however, may collect bacteria and mold, which renders the dishtowel unsanitary.

Another method for drying glassware or stemware is to use a drying rack. In a drying rack system, glassware or stemware is suspended from the rack or rests in grooves. In both cases, the rack is made of a rigid material so that the rack will not bend under the weight of the glassware or stemware. A rack, however, has several disadvantages. Due to the rigidness of the material of which the rack must be made, the glassware or stemware may be cracked or scratched. Further, in the case where the glassware or stemware is suspended, often several feet above a floor, there is always a danger that the glassware or stemware may fall and break.

Another method for drying glassware or stemware is to use a dish rack. However, dish racks are deficient when drying stemware, because the stemware may become unbalanced and fall over. Further, dish racks have wires which contact the interior or exterior surface area of glassware or stemware, impeding the evaporation of any moisture at the contact point.

Another method for drying glassware or stemware is to use a drying mat. In order for a drying mat to function properly, air must be able to flow over the surface of glassware or stemware, causing condensation to evaporate, and water droplets must be able to roll and separate from the surface of the glassware or stemware.

Illustrative, non-limiting embodiments of the present invention overcome the above disadvantages and other disadvantages not described above. However, the present invention is not required to overcome the disadvantages described above, and an illustrative, non-limiting embodiment of the present invention may not overcome any of the problems described above.

### SUMMARY OF THE INVENTION

Aspects of the present invention will become more apparent by describing in detail illustrative, non-limiting embodiments of the present invention with reference to the accompanying drawings, in which:

A mat for drying glassware or stemware, the mat comprising a plurality of elevating portions; a plurality of notches in the elevating portions; a plurality of openings on a surface of the mat; and a plurality of ribs.

According to another aspect of the present invention, a method of drying glassware or stemware is provided, the method comprising resting a glass on a mat, wherein the mat comprises, a plurality of elevating portions; a plurality of notches in the elevating portions; a plurality of openings on a surface of the mat; and a plurality of ribs. The method further provides allowing water to drop from the glass onto the mat and through the plurality of holes; and allowing air to flow through the plurality of notches and the plurality of holes and over an interior and an exterior surface of the glass until condensation on the glass evaporates.

According to another aspect of the present invention, a system for drying glassware is provided, the system comprising a mat and a tray. The mat further comprising a plurality of elevating portions; a plurality of notches in the elevating portions; a plurality of openings on a surface of the mat; and a plurality of ribs.

### BRIEF DESCRIPTION OF THE DRAWINGS

FIG. 1 is a perspective view of an exemplary embodiment of a drying mat of the present invention;

FIG. 2 is a perspective view of an exemplary embodiment of a drying mat of the present invention used in conjunction with a steel tray;

### DETAILED DESCRIPTION OF EXEMPLARY EMBODIMENTS

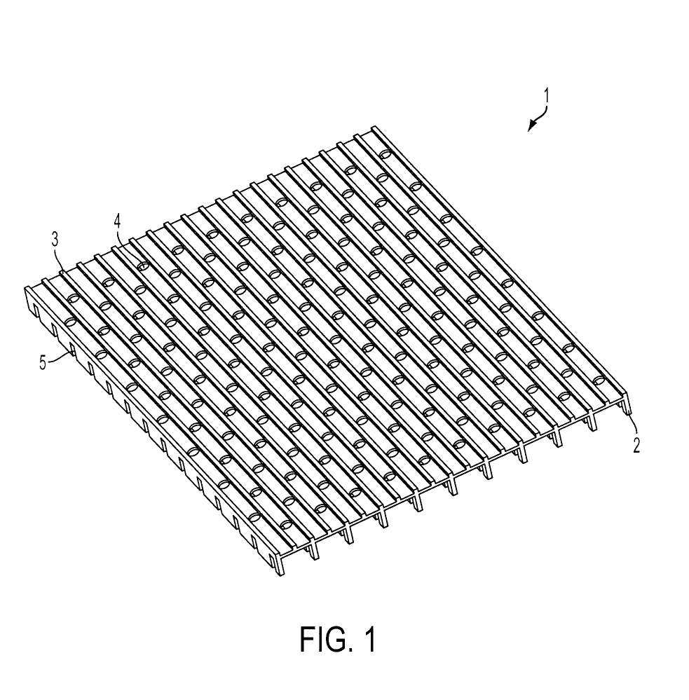

A description of an exemplary embodiment of the present invention will now be made with reference to FIG. 1.

A mat 1, for drying glassware or stemware. The mat 1 comprises elevating portions 2, ribs 3, holes 4 and notches 5. The elevating portions 2, elevate the mat 1 off a resting surface. The elevating portions 2 may run the length of the mat 1, with each elevating portion 2 substantially parallel to the other elevating portions 2. The elevating portions 2 should be substantially parallel so that air may my flow beneath the mat 1, in a direction parallel to the elevating portions 2. There should be space between the elevating portions 2, to allows air to flow beneath the mat 1.

In FIG. 1, the elevating portions 2 are rectangular in shape, however, the elevating portions 2 may be any shape which allows air to flow in the space between the elevating portions 2.

The notches 5 are disposed in the elevating portions 2. The notches 5 are holes in the elevating portions 2, which allow air to flow beneath the mat 1, in a direction substantially perpendicular to the elevating portions 2. The notches 5 should be large enough to allow air to pass through, and should be arranged in the elevating portions 2, so that air may flow beneath the mat 1, from a first edge to a second edge of the mat 1, in a straight line.

In FIG. 1, the notches 5 have a rectangular shape, however, the notch 5 may be any shape which allows air to pass through, such as semi-spherical or triangular.

The ribs 3 are positioned on the reverse side of the mat 1 than the elevating portions 2. The ribs 3 extend the length of the mat 1, and each of the ribs 3 is substantially parallel to the other ribs 3. The ribs 3 act to support any glassware or stemware which is rest on the mat 1. The ribs 3 elevate glassware or stemware above the rest of the mat 1. The ribs 3 should be tall enough and far enough apart to allow air to flow between the surface of the mat 1 and the glassware or stemware.

The holes 4 are made into the surface of the mat 1. The holes 4 may be disposed laterally between the ribs 3 and the elevating portions 2. The holes 4 should be large enough to allow air to flow through. In FIG. 1, the holes 4 are circles, however, the holes 4 may be any shape which allows air and water to flow through and, including rectangular or triangular. In one exemplary embodiment, the holes 4 are arranged above the space between the plurality of elevating portions 2. According to another exemplary embodiment, the holes 4 are arranged so that they are above a line that passes through a notch in a first elevating portion and a notch in a second elevating portion.

The mat 1 should be made of any material which is which is soft, water resilient, and provides sufficient friction between the mat 1 and glass such that the glass does not slip. For example, the mat 1 may be made of silicone, rubber or plastic.

The arrangement of the elevating portions 2, ribs 3, holes 4 and notches 5 in the mat 1, as described above, allows air to flow over substantially all of the interior and exterior surface of glassware or stemware, thereby causing the evaporation of any moisture on the glassware or stemware.

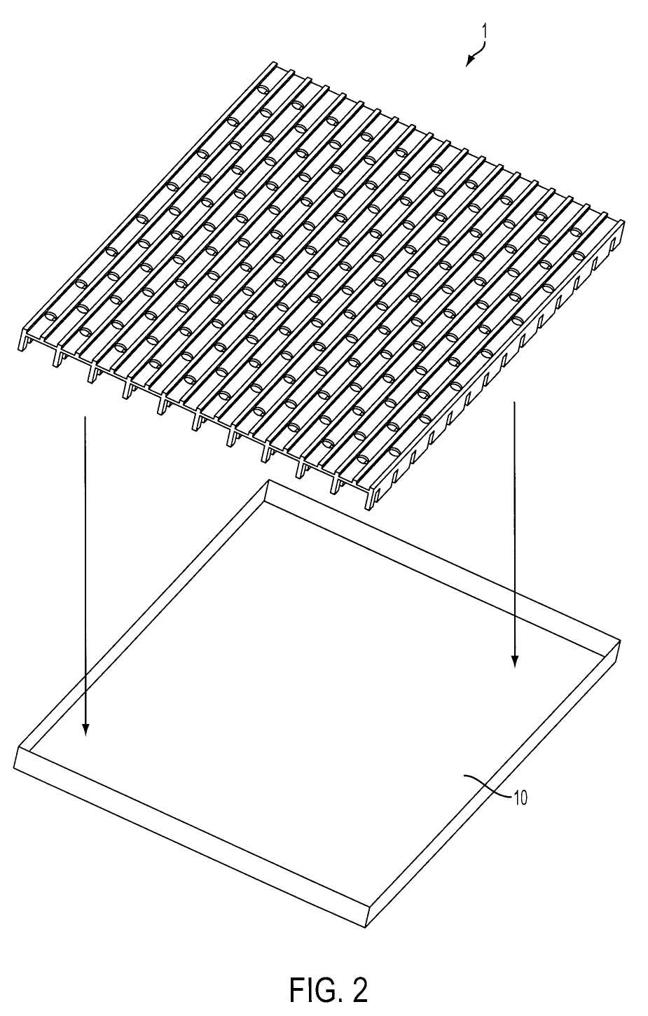

As shown in FIG. 2, the mat 1 may be combined with a tray 10. The tray 10 should have a surface area greater than the mat 1, so that the mat 1 can rest in the tray 10. The tray 10 may collect water from drying glassware or stemware. The tray 10 may also provide a rigid surface upon which the mat 1, and glassware or stemware resting on the mat 1, may be transported safely. The tray 10 may be made out of stainless steel, or any material that is rust resistant.

Next, the operation of drying glassware or stemware will be described according to an exemplary embodiment of the present invention. A recently washed glass is rest on the ribs 3. Water from the washed glass drips onto the mat 1, and falls through the holes 4. If the mat 1 is combined with a tray 10, then the water which drips through the holes 4, collects in the tray 10 for easy disposal. Next the aerated design of the mat 1, allows airflow through the glass, which causes condensation on the glass to evaporate. Air flows between the elevated portions 2, through the notches 5, and through the holes 4 to pass over the surface of glassware and stemware. The air may then flow back through the holes 4 or flow in the space between the glassware and the mat 1 created by the ribs 3. Air may also flow between the mat 1 and the glassware in the space created by the ribs 3, and then over the surface of the glassware or stemware before flowing through the holes 4 or back between the mat 1 and the glassware.

The above description is presented to enable a person skilled in the art to make and use the invention, and is provided in the context of a particular application and its requirements. It is contemplated that numerous modifications to the exemplary embodiments should be readily apparent to those skilled in the art and that the generic principles defined herein may be applied to other embodiments and applications without departing from the spirit and scope of the embodiments of the present invention as defined in the following claims. Thus, the present invention is not intended to be limited to the embodiments disclosed, but is to be accorded the widest scope consistent with the principles and features disclosed herein

What is claimed is:

1. A mat for drying glassware or stemware, the mat comprising:
a plurality of elevating portions;
a plurality of notches in the elevating portions;
a plurality of openings on a surface of the mat; and
a plurality of ribs;

2. The mat according to claim 1, wherein the mat is made of a soft and water resilient material.

3. The mat according to claim 2, wherein the material is silicone, rubber or plastic.

4. The mat according to claim 1, wherein one of the plurality of openings is a round whole or a slit.

5. The mat according to claim 1, wherein the plurality of elevating portions elevate the mat above a supporting surface.

6. The mat according to claim 1, wherein the plurality of ribs and the plurality of elevating portions are disposed on opposing surfaces of the mat.

7. The mat according to claim 1, wherein a first elevating portion of the plurality of elevating portions is substantially parallel to a second elevating portion of the plurality of elevating portions.

8. The mat according to claim 7, wherein a first notch in the first elevating portion and a second notch in the second elevating portion are arranged so that air may flow through the notches in a straight line.

9. The mat according to claim 1, wherein a first rib of the plurality of ribs is are substantially parallel to a second rib of the plurality of ribs.

10. The mat according to claim 9, wherein a group of openings of the plurality of openings are disposed between the first rib of the plurality of ribs and the second rib of the plurality of ribs.

11. The mat according to claim 1, wherein an opening of the plurality of openings is arranged directly above a line which passes through a first notch of the plurality of notches and a second notch of the plurality of notches.

12. A method of drying glassware or stemware, the method comprising:
resting a glass on a mat, wherein the mat comprises:
a plurality of elevating portions;
a plurality of notches in the elevating portions;
a plurality of openings on a surface of the mat; and
a plurality of ribs,
allowing water to drop from the glass onto the mat and through the plurality of holes;
allowing air to flow through the plurality of notches and the plurality of holes and over an interior and an exterior surface of the glass until condensation on the glass evaporates.

13. The method of drying glassware or stemware according to claim 12, wherein resting the glass comprises resting a lip of the bowl against the plurality of ribs such that there is a space between the glass and the mat.

14. The method of drying glassware or stemware according to claim 13, further comprising, positioning the glass above a number of openings of the plurality of openings.

15. The method of drying glassware or stemware according to claim 12, wherein the glass is a wine glass, and the wine glass rests on the mat such that an interior of a bowl of the wine glass faces the mat.

16. A system for drying glassware, the system comprising:
a mat comprising:
a plurality of elevating portions;
a plurality of notches in the elevating portions;
a plurality of openings on a surface of the mat; and
a plurality of ribs, and
a tray.

17. The system for drying glassware according to claim 16, wherein the mat is disposed in the tray.
